(19) United States
(12) Patent Application Publication
(10) Pub. No.: US 2018/0052401 A1
(43) Pub. Date: Feb. 22, 2018

(54) ELECTROPHOTOGRAPHIC PHOTOSENSITIVE MEMBER, PROCESS CARTRIDGE, AND IMAGE-FORMING APPARATUS

(71) Applicant: FUJI XEROX CO., LTD., Tokyo (JP)

(72) Inventors: Yoshiteru YAMADA, Kanagawa (JP); Yohei SAITO, Kanagawa (JP)

(73) Assignee: FUJI XEROX CO., LTD., Tokyo (JP)

(21) Appl. No.: 15/446,629

(22) Filed: Mar. 1, 2017

(30) Foreign Application Priority Data
Aug. 17, 2016 (JP) 2016-160190

(51) Int. Cl. G03G 15/00; G03G 5/047

(52) U.S. Cl. CPC G03G 5/047; G03G 21/18

(57) ABSTRACT

An electrophotographic photosensitive member includes a conductive base, and a single-layer photosensitive layer disposed directly on the conductive base and containing a charge generation material. A difference between a work function of the conductive base and an electron affinity of the charge generation material is in a range of from about −0.1 to about +0.1 eV. A difference between a current Ia and a current Ib is in a range of from about 5.5×10⁻⁸ to about 9.2×10⁻⁸ [A/cm²] when a gold electrode is provided on the photosensitive layer, where the current Ia is a current when an electric field is applied by applying a voltage so that the gold electrode becomes positive, and the current Ib is a current when an electric field is applied by applying a voltage so that the conductive base becomes positive.

### CROSS-REFERENCE TO RELATED APPLICATIONS

This application is based on and claims priority under 35 USC 119 from Japanese Patent Application No. 2016-160190 filed Aug. 17, 2016.

### BACKGROUND

### Technical Field

The present invention relates to an electrophotographic photosensitive member, a process cartridge, and an image-forming apparatus.

### SUMMARY

According to an aspect of the invention, there is provided an electrophotographic photosensitive member including a conductive base, and a single-layer photosensitive layer disposed directly on the conductive base and containing a binder resin, a charge generation material, a hole transport material, and an electron transport material. A difference ΔEa−Ip between a work function Ip of the conductive base and an electron affinity Ea of the charge generation material is in a range of from about −0.1 to about +0.1 eV. A difference ΔIab between a current Ia [A/cm²] and a current Ib [A/cm²] is in a range of from about 5.5×10⁻⁸ to about 9.2×10⁻⁸ [A/cm²] when a gold electrode is provided on the photosensitive layer so as to have a film thickness of 2 nm and an electrode area of 9.3×10⁻¹ cm², where the current Ia is a current that flows per unit area when an electric field of 27 V/μm is applied between the photosensitive layer and the conductive base in an environment at a temperature of 33° C. and a humidity of 80% by applying a voltage so that the gold electrode becomes positive, and the current Ib is a current that flows per unit area when an electric field of 27 V/μm is applied between the photosensitive layer and the conductive base in the environment by applying a voltage so that the conductive base becomes positive.

### BRIEF DESCRIPTION OF THE DRAWINGS

An exemplary embodiment of the present invention will be described in detail based on the following figures, wherein:

FIG. 1 is a schematic partial sectional view illustrating an electrophotographic photosensitive member according to the exemplary embodiment;

FIG. 2 is a schematic structural view illustrating an example of an image-forming apparatus according to the exemplary embodiment; and

FIG. 3 is a schematic structural view illustrating another example of an image-forming apparatus according to the exemplary embodiment.

### DETAILED DESCRIPTION

An exemplary embodiment which is one example of the present invention will now be described.

### Electrophotographic Photosensitive Member

An electrophotographic photosensitive member (hereinafter, may be referred to as “photosensitive member”) according to the exemplary embodiment is a positively charged organic photosensitive member (hereinafter, may be referred to as “single-layer-type photosensitive member”) including a conductive base and a single-layer photosensitive layer disposed on the conductive base directly without providing an undercoating layer therebetween. The single-layer photosensitive layer contains a binder resin, a charge generation material, a hole transport material, and an electron transport material.

A difference ΔEa−Ip between a work function Ip of the conductive base and an electron affinity Ea of the charge generation material is in a range of from −0.1 to +0.1 eV or from about −0.1 to about +0.1 eV. A difference ΔIab between a current Ia [A/cm²] and a current Ib [A/cm²] is in a range of from 5.5×10⁻⁸ to 9.2×10⁻⁸ [A/cm²] or from about 5.5×10⁻⁸ to about 9.2×10⁻⁸ [A/cm²] when a gold electrode is provided on the photosensitive layer so as to have a film thickness of 2 nm and an electrode area of 9.3×10⁻¹ cm², where the current Ia is a current that flows per unit area when an electric field of 27 V/μm is applied between the photosensitive layer and the conductive base in an environment at a temperature of 33° C. and a humidity of 80% by applying a voltage so that the gold electrode becomes positive, and the current Ib is a current that flows per unit area when an electric field of 27 V/μm is applied between the photosensitive layer and the conductive base in the environment by applying a voltage so that the conductive base becomes positive.

Note that the “single-layer photosensitive layer” refers to a photosensitive layer having a hole-transporting property and an electron-transporting property together with a charge generation capability. In addition, the single-layer photosensitive layer forms an outermost surface of the photosensitive member.

Single-layer-type photosensitive members have a feature that the number of coating steps is small and the production cost is low compared with photosensitive members including a multilayer photosensitive layer. Therefore, recently, single-layer-type photosensitive members have attracted attention as, for example, photosensitive members used in low-priced image-forming apparatuses.

In consideration of cost reduction, a photosensitive layer in such a single-layer-type photosensitive member is often disposed directly on a conductive base without providing an undercoating layer. In a photosensitive member in which a photosensitive layer is provided directly on a conductive base, for example, a conductive base subjected to an anodic oxidation treatment may be used. Use of such a conductive base subjected to an anodic oxidation treatment easily suppresses image defects such as color spots. However, performing an anodic oxidation treatment increases man-hours for producing a photosensitive member, resulting in an increase in the production cost.

For single-layer-type photosensitive members, further reduction in the cost is desired while image defects such as color spots are suppressed. In view of this, to realize the cost reduction, it is conceivable that, for example, a photosensitive layer is provided directly on a conductive base that is not subjected to an anodic oxidation treatment. However, in a photosensitive member produced by disposing a single-layer photosensitive layer directly on a conductive base that is not subjected to an anodic oxidation treatment without providing an undercoating layer therebetween, for example, leakage of charges from the photosensitive layer to the conductive base easily occurs in this single-layer-type photosensitive member. Consequently, image defects may be generated by the effect of the leakage of charges. Furthermore, when an image is repeatedly formed in a high-temperature, high-humidity environment (for example, 33° C., 80% RH), corrosion may easily occur in the conductive base. When corrosion in the conductive base occurs, a local charge leakage easily occurs in the single-layer photosensitive layer due to the corrosion, and many color spots tend to be formed.

In contrast, since the photosensitive member of the exemplary embodiment has the configuration described above, for example, even when a photosensitive layer is disposed directly on a conductive base that is not subjected to an anodic oxidation treatment, formation of color spots is suppressed. The reason for this is not clear but is assumed to be as follows.

It is believed that when the difference ΔEa−Ip between the work function of the conductive base and the electron affinity of the charge generation material is in a range of from −0.1 to +0.1 eV or from about −0.1 to about +0.1 eV, the barrier by the charge generation material in the photosensitive layer becomes large, and thus the charge leakage from the photosensitive layer to the conductive base is suppressed (leakage resistance improves).

Furthermore, when the difference ΔEa−Ip satisfies the above range, the occurrence of corrosion of the conductive base is easily suppressed, and the photosensitive member is not easily affected by corrosion in a high-temperature, high-humidity environment. Furthermore, for example, it is also possible to suppress corrosion due to the occurrence of a chemical reaction with the conductive base when a coating liquid for forming a photosensitive layer is applied.

The difference ΔIab between the current Ia [A/cm²] and the current Ib [A/cm²] is in a range of from 5.5×10⁻⁸ to 9.2×10⁻⁸ [A/cm²] or from about 5.5×10⁻⁸ to about 9.2×10⁻⁸ [A/cm²] (preferably, from 5.5×10⁻⁸ to 8.0×10⁻⁸ [A/cm²] or from about 5.5×10⁻⁸ to about 8.0×10⁻⁸ [A/cm²]) when a gold electrode is provided on the photosensitive layer so as to have a film thickness of 2 nm and an electrode area of 9.3×10⁻¹ cm², where the current Ia is a current that flows per unit area when an electric field of 27 V/μm is applied between the photosensitive layer and the conductive base in an environment at a temperature of 33° C. and a humidity of 80% by applying a voltage so that the gold electrode becomes positive, and the current Ib is a current that flows per unit area when an electric field of 27 V/μm is applied between the photosensitive layer and the conductive base in the environment by applying a voltage so that the conductive base becomes positive. The difference ΔIab represents an injection current injected from the photosensitive layer into the conductive base. When the difference ΔIab is in the above range, the injection current injected from the photosensitive layer into the conductive base is in an appropriate range. It is believed that, as a result, formation of color spots is suppressed.

Since the electrophotographic photosensitive member according to the exemplary embodiment has the configuration described above, the charge leakage from the photosensitive layer to the conductive base is suppressed (leakage resistance improves), and the injection current injected into the conductive base is optimized. Thus, it is believed that formation of color spots is consequently suppressed.

The methods for measuring the difference ΔEa−Ip and the difference ΔIab will be described. The difference ΔEa−Ip and the difference ΔIab are measured by the methods described below.

### ΔEa−Ip

### Measurement of Work Function Ip of Conductive Base

In the measurement of the work function of a conductive base (for example, aluminum base), a photoelectron spectrometer (AC-2) manufactured by Riken Keiki Co., Ltd. is used. The measurement is performed in an environment at 20° C. and 40% RH, with a low-energy electron counter, in a detection range of 3.4 eV or more and 6.2 eV or less (364 nm or less and 200 nm or more), and in an amount of light irradiation of 50 nW. An ionization potential (Ip) is estimated from the photoemission threshold on the basis of the irradiation-light energy and the square root of the number of electrons emitted.

The difference ΔEa−Ip is determined by subtracting the work function Ip of the conductive base determined as described above from the electron affinity Ea, which is a value inherent to the charge generation material.

The work function of the conductive base may be adjusted by, for example, washing the conductive base as described below. The electron affinity Ea of the charge generation material is a value inherent to the charge generation material. Accordingly, the difference ΔEa−Ip may be controlled by, for example, the combination of the washed conductive base and the type of charge generation material used in the photosensitive layer.

### ΔIab

### Measurement of ΔIab

In the measurement of the difference ΔIab, a direct-current IV measurement of a ferroelectric substance evaluation system manufactured by Toyo Corporation is performed in an environment at 33° C. and 80% RH. A gold electrode having a thickness of 2 nm is formed in advance on a surface of a photosensitive layer by sputtering so as to have an area of 9.3×10⁻¹ cm². A current that flows per unit area when an electric field of 27 V/μm is applied between the photosensitive layer and the conductive base by applying a voltage so that the gold electrode becomes positive is defined as a current Ia [A/cm²]. Similarly, a current that flows per unit area when an electric field of 27 V/μm is applied between the photosensitive layer and the conductive base by applying a voltage so that the conductive base becomes positive is defined as a current Ib [A/cm²]. The difference ΔIab between the current Ia and the current Ib in this case is determined. The difference ΔIab is evaluated as an injection current from the photosensitive layer into the conductive base.

Herein, the difference ΔIab is a value represented by Ia [A/cm²]−Ib [A/cm²].

The difference ΔIab may be controlled by, for example, the combination of the conductive base, the surface of which has been washed, and the composition of the photosensitive layer (for example, the type of charge generation material or the ratio of charge generation materials when two or more charge generation materials are used).

An electrophotographic photosensitive member according to the exemplary embodiment will be described in detail with reference to the drawings.

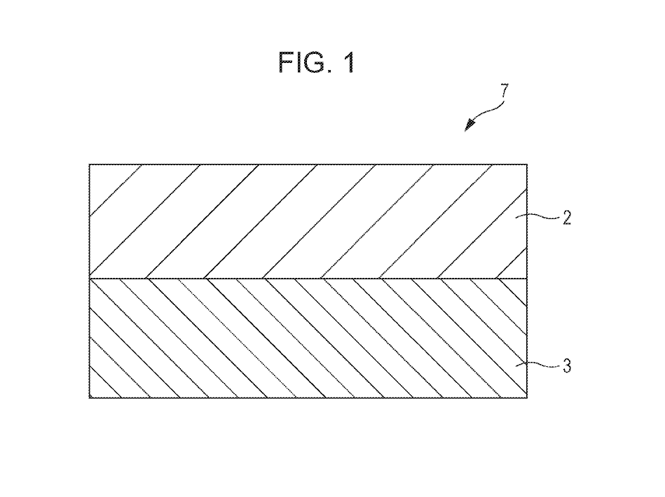

FIG. 1 schematically illustrates a section of a part of an electrophotographic photosensitive member 7 according to the exemplary embodiment.

An electrophotographic photosensitive member 7 illustrated in FIG. 1 includes, for example, a conductive base 3 and a single-layer photosensitive layer 2 disposed directly on the conductive base 3.

The electrophotographic photosensitive member 7 may include a protective layer on the single-layer photosensitive layer 2, as required.

The layers of the electrophotographic photosensitive member according to the exemplary embodiment will be described in detail. Reference numerals are omitted in the description.

### Conductive Base

Examples of the conductive base include metal plates, metal drums, and metal belts containing a metal (such as aluminum, copper, zinc, chromium, nickel, molybdenum, vanadium, indium, gold, or platinum) or an alloy (such as a stainless steel). Examples of the conductive base further include paper, resin films, and belts on which a conductive compound (such as a conductive polymer or indium oxide), a metal (such as aluminum, palladium, or gold), or an alloy is provided by coating, vapor deposition, or lamination. Herein, the term “conductive” means that the volume resistivity is less than 10¹³ Ωcm.

The conductive base according to the exemplary embodiment is preferably, for example, a plate, drum, or belt formed of a metal or an alloy, and more preferably, for example, a plate, drum, or belt formed of aluminum.

The work function (Ip) of the conductive base may be, for example, 3.80 eV or more and 4.05 eV or less (preferably 3.80 eV or more and 3.90 eV or less) from the viewpoint of suppressing charge leakage and formation of color spots.

The work function (Ip) of the conductive base may be controlled by, for example, washing a surface of the conductive base with water having a pH of 7.0 or more and 9.5 or less (hereinafter, may be referred to as “weakly alkaline water”). In the conductive base, at least a surface on which a photosensitive layer is to be disposed may come in contact with weakly alkaline water.

When the pH of the water used for washing the surface of the conductive base is less than 7.0, the surface of the conductive base is easily oxidized, and the conductive base is easily corroded. When the pH of the water exceeds 9.5, the surface of the conductive base easily degrades. The pH of water used for washing the conductive base is preferably 7.0 or more and 9.0 or less, more preferably more than 7.0 and 8.5 or less, and still more preferably more than 7.0 and 8.0 or less.

The pH of water changes depending on the water temperature. In the exemplary embodiment, the pH of water when the conductive base is washed (when the water comes in contact with the conductive base) is preferably in the above range.

Weakly alkaline water may be prepared by, for example, treating water with a reverse osmosis membrane. The pH of water may be adjusted by, for example, electrolysis of water.

The temperature of weakly alkaline water is not limited. For example, the temperature of weakly alkaline water is preferably 25° C. or more and 70° C. or less, more preferably 35° C. or more and 65° C. or less, and still more preferably 45° C. or more and 50° C. or less.

Examples of the method for washing the conductive base with weakly alkaline water include a method in which the conductive base is immersed in weakly alkaline water and a method in which weakly alkaline water is sprayed onto the conductive base. The conductive base may be washed with weakly alkaline water once or twice or more. Specifically, for example, immersing the conductive base in weakly alkaline water may be performed twice or more.

The time during which the conductive base is in contact with weakly alkaline water is not limited. For example, the time is preferably 10 seconds or more and 180 seconds or less, more preferably 30 seconds or more and 120 seconds or less, and still more preferably 60 seconds or more and 100 seconds or less.

After the conductive base is washed, the weakly alkaline water in contact with the surface of the conductive base may be removed from the surface of the conductive base. An example of the method for removing weakly alkaline water from the surface of the conductive base is a method in which weakly alkaline water is evaporated by heat treatment.

A production method according to the exemplary embodiment may include other steps before the conductive base is washed (the step of washing the conductive base). Examples of the other steps include known steps that are performed on metal components, such as a step of degreasing and washing a surface of the conductive base, a step of washing the degreased and washed conductive base with water, and a step of further rinsing the water-washed conductive base with water.

For example, a top surface of a conductive base after being washed with weakly alkaline water (pH 8.1) has a ratio of C:O:Al=45.6:24.9:29.5.

The ratio is determined by the following method. A conductive base is cut to have a shape of 1 square centimeters, and components adhering to the surface are analyzed by X-ray photoelectron spectroscopy (XPS). First, a wide spectrum of the sample is measured, and three elements of C, O, and Al are extracted from the observed peak values. Subsequently, narrow spectra of these components are measured to determine the above ratio.

### Single-Layer Photosensitive Layer

The single-layer photosensitive layer contains a binder resin, a charge generation material, a hole transport material, and an electron transport material and may optionally contain other additives.

### Binder Resin

Examples of the binder resin include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilanes. These binder resins may be used alone or as a mixture of two or more resins.

Among these binder resins, polycarbonate resins and polyarylate resins are preferable from the viewpoint of, for example, mechanical strength of the photosensitive layer.

From the viewpoint of film-formability of the photosensitive layer, at least one of a polycarbonate resin having a viscosity-average molecular weight of 30,000 or more and 80,000 or less and a polyarylate resin having a viscosity-average molecular weight of 30,000 or more and 80,000 or less may be used.

The viscosity-average molecular weight is a value measured by the method described below. One gram of a resin is dissolved in 100 cm³ of methylene chloride, and a specific viscosity lisp of the resulting solution is measured with an Ubbelohde viscometer in a measurement environment at 25° C. A limiting viscosity [η] (cm³/g) is determined from a formula ηsp/c=[η]+0.45 [η]²c (where c represents a concentration (g/cm³)). The viscosity-average molecular weight My is determined from a formula [η]=1.23×10⁻⁴ Mv^{0.83} given by H. Schnell.

The content of the binder resin relative to the total solid content of the photosensitive layer is, for example, from 35% to 60% by weight, and preferably from 40% to 55% by weight.

### Charge Generation Material

The charge generation material is not limited as long as the difference ΔEa−Ip satisfies the above range.

The electron affinity (Ea) of the charge generation material is, for example, from 3.8 to 4.0 eV (preferably, from 3.8 to 3.9 eV) from the viewpoint of suppressing charge leakage and formation of color spots.

Two or more charge generation materials having different electron affinities (Ea) may be used. In such a case, the electron affinity (Ea) of the charge generation materials means an electron affinity (Ea) of a charge generation material having the highest content (weight ratio) among the two or more charge generation materials contained in the photosensitive layer. In contrast, when the charge generation materials have the same content, the average of the electron affinities (Ea) of the charge generation materials is defined as the electron affinity (Ea).

The charge generation material will be described in detail.

Examples of the charge generation material include azo pigments such as bisazo pigments and trisazo pigments; condensed ring aromatic pigments such as dibromoanthanthrone; perylene pigments; pyrrolopyrrole pigments; phthalocyanine pigments; zinc oxide; and trigonal selenium.

For laser exposure in the near-infrared region, among these, a metal phthalocyanine pigment or a metal-free phthalocyanine pigment may be used as the charge generation material. Specifically, examples thereof include hydroxygallium phthalocyanine, chlorogallium phthalocyanine, dichlorotin phthalocyanine, and titanyl phthalocyanine.

On the other hand, for laser exposure in the near-ultraviolet region, for example, a condensed ring aromatic pigment such as dibromoanthanthrone, a thioindigo pigment, a porphyrazine compound, zinc oxide, trigonal selenium, or a bisazo pigment may be used as the charge generation material.

Specifically, when a light source having an exposure wavelength of 380 nm or more and 500 nm or less is used, inorganic pigments are preferably used as the charge generation material. When a light source having an exposure wavelength of 700 nm or more and 800 nm or less is used, metal phthalocyanine pigments and metal-free phthalocyanine pigments are preferably used as the charge generation material.

In particular, at least one selected from hydroxygallium phthalocyanine pigments and chlorogallium phthalocyanine pigments is preferably used as the charge generation material. These charge generation materials may be used alone or as a mixture of two or more pigments. From the viewpoint of increasing the sensitivity of the photosensitive member, hydroxygallium phthalocyanine pigments are preferable.

When a hydroxygallium phthalocyanine pigment and a chlorogallium phthalocyanine pigment are used in combination, a ratio of the hydroxygallium phthalocyanine pigment to the chlorogallium phthalocyanine pigment is, in terms of weight ratio, hydroxygallium phthalocyanine pigment:chlorogallium phthalocyanine pigment=9:1 to 3:7 (preferably, 7:3 to 3:7 or about 7:3 to about 3:7).

The hydroxygallium phthalocyanine pigment is not limited but is preferably a type V hydroxygallium phthalocyanine pigment.

In particular, from the viewpoint of obtaining further improved dispersibility, the hydroxygallium phthalocyanine pigment is preferably, for example, a hydroxygallium phthalocyanine pigment having a maximum peak wavelength in the range of 810 nm or more and 839 nm or less in a spectral absorption spectrum in the wavelength range of 600 nm or more and 900 nm or less.

The hydroxygallium phthalocyanine pigment having a maximum peak wavelength in the range of 810 nm or more and 839 nm or less preferably has an average particle size in a particular range and a BET specific surface area in a particular range. Specifically, the average particle size is preferably 0.20 μm or less, and more preferably 0.01 μm or more and 0.15 μm or less. The BET specific surface area is preferably 45 m²/g or more, more preferably 50 m²/g or more, and still more preferably 55 m²/g or more and 120 m²/g or less. The average particle size is a volume average particle size and is a value measured with a laser diffraction/scattering particle size distribution analyzer (LA-700 manufactured by HORIBA, Ltd.). The BET specific surface area is a value measured by the nitrogen replacement method using a fluid-type specific surface area automatic measuring device (FlowSorb II2300 manufactured by Shimadzu Corporation).

The maximum particle size (maximum of the primary particle size) of the hydroxygallium phthalocyanine pigment is preferably 1.2 μm or less, more preferably 1.0 μm or less, and still more preferably 0.3 μm or less.

The hydroxygallium phthalocyanine pigment preferably has an average particle size of 0.2 μm or less, a maximum particle size of 1.2 μm or less, and a BET specific surface area of 45 m²/g or more.

The hydroxygallium phthalocyanine pigment is preferably a type V hydroxygallium phthalocyanine pigment having diffraction peaks at Bragg angles (2θ±0.2°) of at least 7.3°, 16.0°, 24.9°, and 28.0° in an X-ray diffraction spectrum obtained using a CuKα X-ray.

On the other hand, the chlorogallium phthalocyanine pigment is preferably a compound having diffraction peaks at Bragg angles (2θ±0.2°) of 7.4°, 16.6°, 25.5°, and 28.3° from the viewpoint of the sensitivity of the photosensitive layer. Preferred ranges of the maximum peak wavelength, the average particle size, the maximum particle size, and the BET specific surface area of the chlorogallium phthalocyanine pigment are the same as those of the hydroxygallium phthalocyanine pigment.

The charge generation materials may be used alone or in combination of two or more thereof.

The content of the charge generation material relative to the total solid content of the single-layer photosensitive layer is preferably 1% to 5% by weight, and more preferably 1.2% to 4.5% by weight.

### Hole Transport Material

Examples of the hole transporting material include, but are not limited to, oxadiazole derivatives such as 2,5-bis(p-diethylaminophenyl)-1,3,4-oxadiazole; pyrazoline derivatives such as 1,3,5-triphenyl pyrazoline and 1-[pyridyl-(2)]-3-(p-diethylaminostyryl)-5-(p-diethylaminostyryl)pyrazoline; aromatic tertiary amino compounds such as triphenylamine, N,N′-bis(3,4-dimethylphenyl)biphenyl-4-amine, tri(p-methylphenyl)aminyl-4-amine, and dibenzylaniline; aromatic tertiary diamino compounds such as N,N′-bis(3-methylphenyl)-N,N′-diphenylbenzidine; 1,2,4-triazine derivatives such as 3-(4′-dimethylaminophenyl)-5,6-di-(4′-methoxyphenyl)-1,2,4-triazine; hydrazone derivatives such as 4-diethylaminobenzaldehyde-1,1-diphenylhydrazone; quinazoline derivatives such as 2-phenyl-4-styryl-quinazoline; benzofuran derivatives such as 6-hydroxy-2,3-di-(p-methoxyphenyl)benzofuran; α-stilbene derivatives such as p-(2,2-diphenylvinyl)-N,N-diphenylaniline; enamine derivatives; carbazole derivatives such as N-ethylcarbazole; poly(N-vinylcarbazole) and derivatives thereof; and polymers having a group formed of any of the above compounds in a main chain or a side chain. These hole transport materials may be used alone or in combination of two or more thereof.

Specific examples of the hole transport material include compounds represented by general formula (B-1) below and compounds represented by general formula (B-2) below. Specific examples thereof further include compounds represented by general formula (1) below. Among these, a hole transport material represented by general formula (1) below is preferably used from the viewpoint of charge mobility.

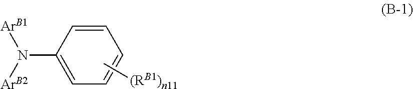

In general formula (B-1), R^{B1} represents a hydrogen atom or a methyl group; n11 represents 1 or 2; Ar^{B1} and Ar^{B2} each independently represent a substituted or unsubstituted aryl group, —C₆H₄—C(R^{B3})═C(R^{B4})(R^{B5}), or —C₆H₄—CH═CH—CH═C(R^{B6})(R^{B7}); and R^{B3} to R^{B7} each independently represent a hydrogen atom, a substituted or unsubstituted alkyl group, or a substituted or unsubstituted aryl group. The substituent represents a halogen atom, an alkyl group having from 1 to 5 carbon atoms, an alkoxy group having from 1 to 5 carbon atoms, or a substituted amino group substituted with an alkyl group having from 1 to 3 carbon atoms.

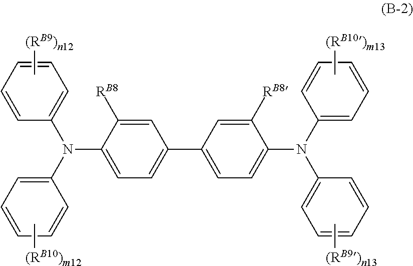

In general formula (B-2), R^{B8} and R^{B8}′ may be the same or different and each independently represent a hydrogen atom, a halogen atom, an alkyl group having from 1 to 5 carbon atoms, or an alkoxy group having from 1 to 5 carbon atoms; R^{B9}, R^{B9}′, R^{B10}, and R^{B10}′ may be the same or different and each independently represent a halogen atom, an alkyl group having from 1 to 5 carbon atoms, an alkoxy group having from 1 to 5 carbon atoms, an amino group substituted with an alkyl group having from 1 to 2 carbon atoms, a substituted or unsubstituted aryl group, —C(R^{B11})═C(R^{B12})(R^{B13}), or —CH═CH—CH═C(R^{B14})(R^{B15}); R^{B11} to RB¹⁵ each independently represent a hydrogen atom, a substituted or unsubstituted alkyl group, or a substituted or unsubstituted aryl group; and m12, m13, n12, and n13 each independently represent an integer of from 0 to 2.

Among the compounds represented by general formula (B-1) and the compounds represented by general formula (B-2), compounds represented by general formula (B-1) having “—C₆H₄—CH═CH—CH═C(R^{B6})(R^{B7})” and compounds represented by general formula (B-2) having “—CH═CH—CH═C(R^{B14})(R^{B15}) ” are particularly preferable.

Specific examples of the compounds represented by general formula (B-1) and the compounds represented by general formula (B-2) include compounds having structural formulae (HT-A) to (HT-G) below. However, the hole transport material is not limited to the compounds.

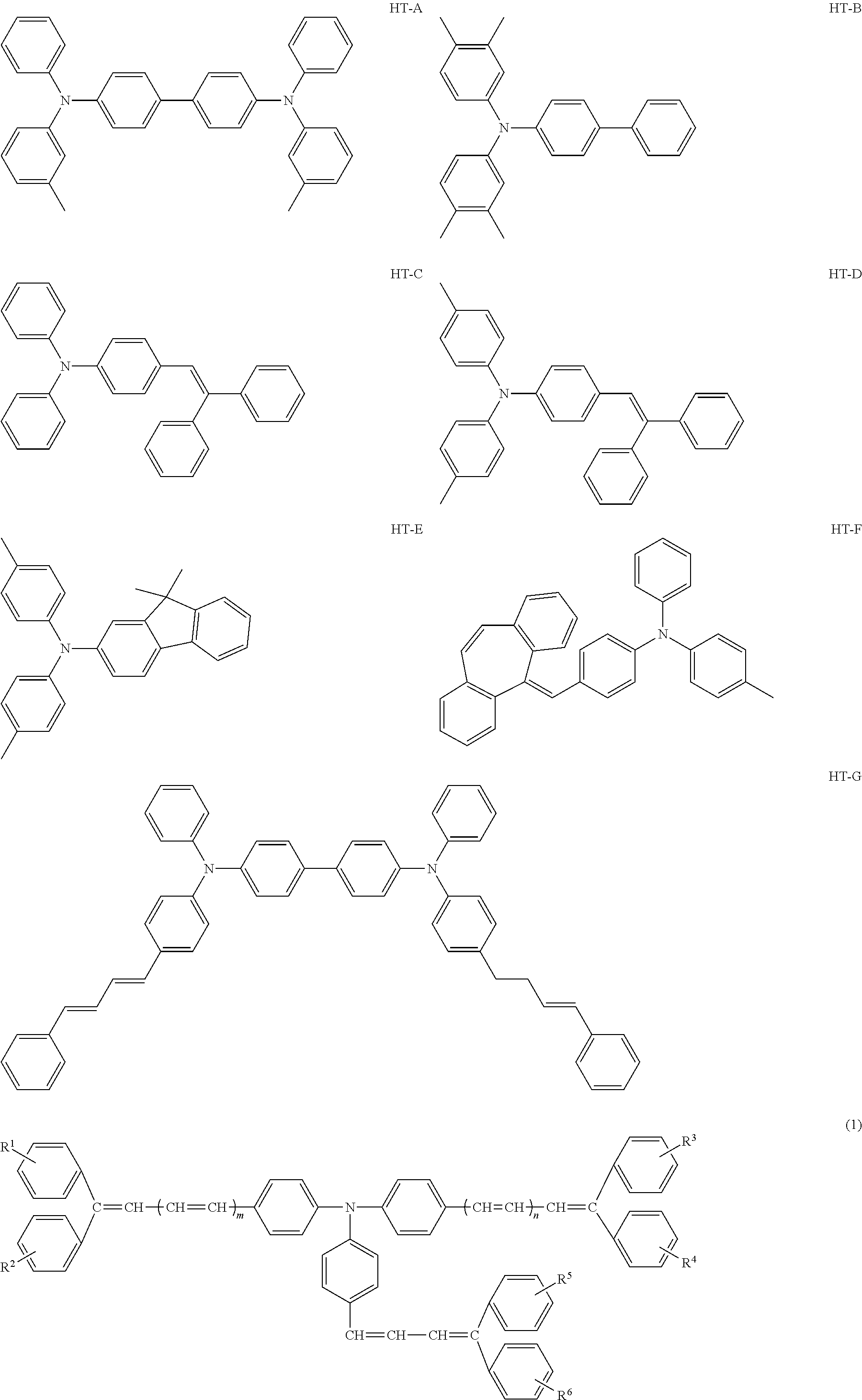

In general formula (1), R¹, R², R³, R⁴, R⁵, and R⁶ each independently represent a hydrogen atom, an alkyl group, an alkoxy group, a phenoxy group, a halogen atom, or a phenyl group optionally substituted with an alkyl group, an alkoxy group, or a halogen atom; and m and n each independently represent 0 or 1.

Examples of the alkyl group represented by R¹ to R⁶ in general formula (1) include linear or branched alkyl groups having from 1 to 4 carbon atoms. Specific examples thereof include a methyl group, an ethyl group, a n-propyl group, an isopropyl group, a n-butyl group, and an isobutyl group. Among these, a methyl group and an ethyl group are preferable as the alkyl group.

Examples of the alkoxy group represented by R¹ to R⁶ in general formula (1) include alkoxy groups having from 1 to 4 carbon atoms. Specific examples thereof include a methoxy group, an ethoxy group, a propoxy group, and a butoxy group.

Examples of the halogen atom represented by R¹ to R⁶ in general formula (1) include a fluorine atom, a chlorine atom, a bromine atom, and an iodine atom.

Examples of the phenyl group represented by R¹ to R⁶ in general formula (1) include an unsubstituted phenyl group; phenyl groups substituted with an alkyl group, such as a p-tolyl group and a 2,4-dimethylphenyl group; phenyl groups substituted with an alkoxy group, such as a p-methoxyphenyl group; and a phenyl group substituted with a halogen atom, such as a p-chlorophenyl group.

Examples of the substituents for the phenyl group include the alkyl groups, alkoxy groups, and halogen atoms which are the same as those represented by R¹ to R⁶.

Among the hole transport materials represented by general formula (1), from the viewpoint of increasing the sensitivity, hole transport materials in which m and n each represent 1 are preferable, and hole transport materials in which R¹ to R⁶ each independently represent a hydrogen atom, an alkyl group having from 1 to 4 carbon atoms, or an alkoxy group, and m and n each represent 1 are preferable.

Specific examples of the compounds represented by general formula (1) include, but are not limited to, compounds (1-1) to (1-64) below. The number added before each substituent represents the substitution position on a benzene ring.

| Exemplary | | | | | | | | |
|---|---|---|---|---|---|---|---|---|
| Compound | m | n | R¹ | R² | R³ | R⁴ | R⁵ | R⁶ |
| 1 | 1 | 1 | H | H | H | H | H | H |
| 2 | 1 | 1 | 4-Me | 4-Me | 4-Me | 4-Me | 4-Me | 4-Me |
| 3 | 1 | 1 | 4-Me | 4-Me | H | H | 4-Me | 4-Me |
| 4 | 1 | 1 | 4-Me | H | 4-Me | H | 4-Me | H |
| 5 | 1 | 1 | H | H | 4-Me | 4-Me | H | H |
| 6 | 1 | 1 | 3-Me | 3-Me | 3-Me | 3-Me | 3-Me | 3-Me |
| 7 | 1 | 1 | H | H | H | H | 4-Cl | 4-Cl |
| 8 | 1 | 1 | 4-MeO | H | 4-MeO | H | 4-MeO | H |
| 9 | 1 | 1 | H | H | H | H | 4-MeO | 4-MeO |
| 10 | 1 | 1 | 4-MeO | 4-MeO | 4-MeO | 4-MeO | 4-MeO | 4-MeO |
| 11 | 1 | 1 | 4-MeO | H | 4-MeO | H | 4-MeO | 4-MeO |
| 12 | 1 | 1 | 4-Me | H | 4-Me | H | 4-Me | 4-F |
| 13 | 1 | 1 | 3-Me | H | 3-Me | H | 3-Me | H |
| 14 | 1 | 1 | 4-Cl | H | 4-Cl | H | 4-Cl | H |
| 15 | 1 | 1 | 4-Cl | 4-Cl | 4-Cl | 4-Cl | 4-Cl | 4-Cl |
| 16 | 1 | 1 | 3-Me | 3-Me | 3-Me | 3-Me | 3-Me | 3-Me |
| 17 | 1 | 1 | 4-Me | 4-MeO | 4-Me | 4-MeO | 4-Me | 4-MeO |
| 18 | 1 | 1 | 3-Me | 4-MeO | 3-Me | 4-MeO | 3-Me | 4-MeO |
| 19 | 1 | 1 | 3-Me | 4-Cl | 3-Me | 4-Cl | 3-Me | 4-Cl |
| 20 | 1 | 1 | 4-Me | 4-Cl | 4-Me | 4-Cl | 4-Me | 4-Cl |
| 21 | 1 | 0 | H | H | H | H | H | H |
| 22 | 1 | 0 | 4-Me | 4-Me | 4-Me | 4-Me | 4-Me | 4-Me |
| 23 | 1 | 0 | 4-Me | 4-Me | H | H | 4-Me | 4-Me |
| 24 | 1 | 0 | H | H | 4-Me | 4-Me | H | H |
| 25 | 1 | 0 | H | H | 3-Me | 3-Me | H | H |
| 26 | 1 | 0 | H | H | 4-Cl | 4-Cl | H | H |
| 27 | 1 | 0 | 4-Me | H | H | H | 4-Me | H |
| 28 | 1 | 0 | 4-MeO | H | H | H | 4-MeO | H |
| 20 | 1 | 0 | H | H | 4-MeO | 4-MeO | H | H |
| 30 | 1 | 0 | 4-MeO | 4-MeO | 4-MeO | 4-MeO | 4-MeO | 4-MeO |
| 31 | 1 | 0 | 4-MeO | H | 4-MeO | H | 4-MeO | 4-MeO |
| 32 | 1 | 0 | 4-Me | H | 4-Me | H | 4-Me | 4-F |
| 33 | 1 | 0 | 3-Me | H | 3-Me | H | 3-Me | H |
| 34 | 1 | 0 | 4-Cl | H | 4-Cl | H | 4-Cl | H |
| 35 | 1 | 0 | 4-Cl | 4-Cl | 4-Cl | 4-Cl | 4-Cl | 4-Cl |
| 36 | 1 | 0 | 3-Me | 3-Me | 3-Me | 3-Me | 3-Me | 3-Me |
| 37 | 1 | 0 | 4-Me | 4-MeO | 4-Me | 4-MeO | 4-Me | 4-MeO |
| 38 | 1 | 0 | 3-Me | 4-MeO | 3-Me | 4-MeO | 3-Me | 4-MeO |
| 39 | 1 | 0 | 3-Me | 4-Cl | 3-Me | 4-Cl | 3-Me | 4-Cl |
| 40 | 1 | 0 | 4-Me | 4-Cl | 4-Me | 4-Cl | 4-Me | 4-Cl |
| 41 | 0 | 0 | H | H | H | H | H | H |
| 42 | 0 | 0 | 4-Me | 4-Me | 4-Me | 4-Me | 4-Me | 4-Me |
| 43 | 0 | 0 | 4-Me | 4-Me | 4-Me | 4-Me | H | H |
| 44 | 0 | 0 | 4-Me | H | 4-Me | H | H | H |
| 45 | 0 | 0 | H | H | H | H | 4-Me | 4-Me |
| 46 | 0 | 0 | 3-Me | 3-Me | 3-Me | 3-Me | H | H |
| 47 | 0 | 0 | H | H | H | H | 4-Cl | 4-Cl |
| 48 | 0 | 0 | 4-MeO | H | 4-MeO | H | H | H |
| 49 | 0 | 0 | H | H | H | H | 4-MeO | 4-MeO |
| 50 | 0 | 0 | 4-MeO | 4-MeO | 4-MeO | 4-MeO | 4-MeO | 4-MeO |
| 51 | 0 | 0 | 4-MeO | H | 4-MeO | H | 4-MeO | 4-MeO |
| 52 | 0 | 0 | 4-Me | H | 4-Me | H | 4-Me | 4-F |
| 53 | 0 | 0 | 3-Me | H | 3-Me | H | 3-Me | H |
| 54 | 0 | 0 | 4-Cl | H | 4-Cl | H | 4-Cl | H |
| 55 | 0 | 0 | 4-Cl | 4-Cl | 4-Cl | 4-Cl | 4-Cl | 4-Cl |
| 56 | 0 | 0 | 3-Me | 3-Me | 3-Me | 3-Me | 3-Me | 3-Me |
| 57 | 0 | 0 | 4-Me | 4-MeO | 4-Me | 4-MeO | 4-Me | 4-MeO |
| 58 | 0 | 0 | 3-Me | 4-MeO | 3-Me | 4-MeO | 3-Me | 4-MeO |
| 59 | 0 | 0 | 3-Me | 4-Cl | 3-Me | 4-Cl | 3-Me | 4-Cl |
| 60 | 0 | 0 | 4-Me | 4-Cl | 4-Me | 4-Cl | 4-Me | 4-Cl |
| 61 | 1 | 1 | 4-Pr | 4-Pr | 4-Pr | 4-Pr | 4-Pr | 4-Pr |
| 62 | 1 | 1 | 4-PhO | 4-PhO | 4-PhO | 4-PhO | 4-PhO | 4-PhO |
| 63 | 1 | 1 | H | 4-Me | H | 4-Me | H | 4-Me |
| 64 | 1 | 1 | 4-C₆H₅ | 4-C₆H₅ | 4-C₆H₅ | 4-C₆H₅ | 4-C₆H₅ | 4-C₆H₅ |

The abbreviations used in Exemplary Compounds above are as follows.
4-Me: a methyl group substituting the 4-position of the phenyl group
3-Me: a methyl group substituting the 3-position of the phenyl group
4-Cl: a chlorine atom substituting the 4-position of the phenyl group
4-MeO: a methoxy group substituting the 4-position of the phenyl group
4-F: a fluorine atom substituting the 4-position of the phenyl group
4-Pr: a propyl group substituting the 4-position of the phenyl group
4-PhO: a phenoxy group substituting the 4-position of the phenyl group

### Electron Transport Material

Examples of the electron transport material include, but are not limited to, quinone compounds such as chloranil and bromanil; tetracyanoquinodimethane compounds; fluorenone compounds such as 2,4,7-trinitro-9-fluorenone, 2,4,5,7-tetranitro-9-fluorenone, octyl 9-dicyanomethylene-9-fluorenone-4-carboxylate; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)1,3,4-oxadiazole; xanthone compounds; thiophene compounds; dinaphthoquinone compounds such as 3,3′-di-tert-pentyl-dinaphthoquinone; diphenoquinone compounds such as 3,3′-di-tert-butyl-5,5′-dimethyl diphenoquinone and 3,3′,5,5′-tetra-tert-butyl-4,4′-diphenoquinone; and polymers having a group formed of any of the above compounds in a main chain or a side chain. These electron transport materials may be used alone or in combination of two or more thereof.

From the viewpoint of increasing sensitivity, the electron transport material is preferably a compound represented by general formula (2) below.

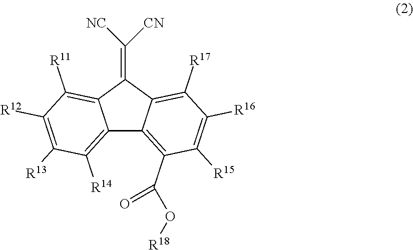

In general formula (2), R¹¹, R¹², R¹³, R¹⁴, R¹⁵, R¹⁶, and R¹⁷ each independently represent a hydrogen atom, a halogen atom, an alkyl group, an alkoxy group, an aryl group, or an aralkyl group; and R^{H} represents an alkyl group, -L¹⁹-O—R²⁰, an aryl group, or an aralkyl group where L¹⁹ represents an alkylene group and R²⁰ represents an alkyl group.

Examples of the halogen atom represented by R¹¹ to R¹⁷ in general formula (2) include a fluorine atom, a chlorine atom, a bromine atom, and an iodine atom.

Examples of the alkyl group represented by R¹¹ to R¹⁷ in general formula (2) include linear or branched alkyl groups having from 1 to 4 (preferably from 1 to 3) carbon atoms. Specific examples thereof include a methyl group, an ethyl group, a n-propyl group, an isopropyl group, a n-butyl group, and an isobutyl group.

Examples of the alkoxy group represented by R¹¹ to R¹⁷ in general formula (2) include alkoxy groups having from 1 to 4 (preferably from 1 to 3) carbon atoms. Specific examples thereof include a methoxy group, an ethoxy group, a propoxy group, and a butoxy group.

Examples of the aryl group represented by R¹¹ to R¹⁷ in general formula (2) include a phenyl group and a tolyl group. Among these, a phenyl group is preferable as the aryl group represented by R¹¹ to R¹⁷.

Examples of the aralkyl group represented by R¹¹ to R¹⁷ in general formula (2) include a benzyl group, a phenethyl group, and a phenylpropyl group.

Examples of the alkyl group represented by R¹⁸ in general formula (2) include linear alkyl groups having from 1 to 12 (preferably from 5 to 10) carbon atoms and branched alkyl groups having from 3 to 10 (preferably from 5 to 10) carbon atoms.

Examples of the linear alkyl group having from 1 to 12 carbon atoms include a methyl group, an ethyl group, a n-propyl group, a n-butyl group, a n-pentyl group, a n-hexyl group, n-heptyl group, a n-octyl group, a n-nonyl group, a n-decyl group, a n-undecyl group, and a n-dodecyl group.

Examples of the branched alkyl group having from 3 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

In the group represented by -L¹⁹-O—R²⁰ represented by R¹⁸ in general formula (2), L¹⁹ represents an alkylene group and R²⁰ represents an alkyl group.

Examples of the alkylene group represented by L¹⁹ include linear or branched alkylene groups having from 1 to 12 carbon atoms. Specific examples thereof include a methylene group, an ethylene group, a n-propylene group, an isopropylene group, a n-butylene group, an isobutylene group, a sec-butylene group, a tert-butylene group, a n-pentylene group, an isopentylene group, a neopentylene group, and a tert-pentylene group.

Examples of the alkyl group represented by R²⁰ include the same groups as the alkyl groups represented by R¹¹ to R¹⁷.

Examples of the aryl group represented by R¹⁸ in general formula (2) include a phenyl group, a methylphenyl group, a dimethylphenyl group, and an ethylphenyl group.

From the viewpoint of solubility, the aryl group represented by R¹⁸ is preferably an alkyl-substituted aryl group substituted with an alkyl group. Examples of the alkyl group of the alkyl-substituted aryl group include the same groups as the alkyl groups represented by R¹¹ to R¹⁷.

Examples of the aralkyl group represented by R¹⁸ in general formula (2) include groups represented by -L²¹-Ar where L²¹ represents an alkylene group and Ar represents an aryl group.

Examples of the alkylene group represented by L²¹ include linear or branched alkylene groups having from 1 to 12 carbon atoms. Specific examples thereof include a methylene group, an ethylene group, a n-propylene group, an isopropylene group, a n-butylene group, an isobutylene group, a sec-butylene group, a tert-butylene group, a n-pentylene group, an isopentylene group, a neopentylene group, and a tert-pentylene group.

Examples of the aryl group represented by Ar include a phenyl group, a methylphenyl group, a dimethylphenyl group, and an ethylphenyl group.

Examples of the aralkyl group represented by R¹⁸ in general formula (2) include a benzyl group, a methylbenzyl group, a dimethylbenzyl group, a phenylethyl group, a methylphenylethyl group, a phenylpropyl group, and a phenylbutyl group.

From the viewpoint of increasing the sensitivity, the electron transport material represented by general formula (2) is preferably an electron transport material in which R¹⁸ represents an alkyl group having from 5 to 10 carbon atoms or an aralkyl group, and particularly preferably an electron transport material in which R¹¹ to R¹⁷ each independently represent a hydrogen atom, a halogen atom, or an alkyl group, and R¹⁸ represents an alkyl group having from 5 to 10 carbon atoms or an aralkyl group.

Exemplary Compounds of the electron transport material represented by general formula (2) are shown below, but are not limited thereto. Regarding the reference numeral of Exemplary Compound, the Exemplary Compound is hereinafter denoted by “Exemplary Compound (2-number)”. Specifically, for example, Exemplary Compound 15 is hereinafter denoted by “Exemplary Compound (2-15)”.

| Exemparly | | | | | | | | |
|---|---|---|---|---|---|---|---|---|
| Compound | R¹¹ | R¹² | R¹³ | R¹⁴ | R¹⁵ | R¹⁶ | R¹⁷ | R¹⁸ |
| 1 | H | H | H | H | H | H | H | —n-C₇H₁₅ |
| 2 | H | H | H | H | H | H | H | —n-C₈H₁₇ |
| 3 | H | H | H | H | H | H | H | —n-C₅H₁₁ |
| 4 | H | H | H | H | H | H | H | —n-C₁₀H₂₁ |
| 5 | Cl | Cl | Cl | Cl | Cl | Cl | Cl | —n-C₇H₁₅ |
| 6 | H | Cl | H | Cl | H | Cl | Cl | —n-C₇H₁₅ |
| 7 | CH₃ | CH₃ | CH₃ | CH₃ | CH₃ | CH₃ | CH₃ | —n-C₇H₁₅ |
| 8 | C₄H₉ | C₄H₉ | C₄H₉ | C₄H₉ | C₄H₉ | C₄H₉ | C₄H₉ | —n-C₇H₁₅ |
| 9 | CH₃O | H | CH₃O | H | CH₃O | H | CH₃O | —n-C₈H₁₇ |
| 10 | C₆H₅ | C₆H₅ | C₆H₅ | C₆H₅ | C₆H₅ | C₆H₅ | C₆H₅ | —n-C₈H₁₇ |
| 11 | H | H | H | H | H | H | H | —n-C₄H₉ |
| 12 | H | H | H | H | H | H | H | —n-C₁₁H₂₃ |
| 13 | H | H | H | H | H | H | H | —n-C₉H₁₉ |
| 14 | H | H | H | H | H | H | H | —CH₂—CH(C₂H₅)—C₄H₉ |
| 15 | H | H | H | H | H | H | H | —(CH₂)₂—Ph |
| 16 | H | H | H | H | H | H | H | —CH₂—Ph |
| 17 | H | H | H | H | H | H | H | —n-C₁₂H₂₅ |
| 18 | H | H | H | H | H | H | H | —C₂H₄—O—CH₃ |

The abbreviations used in Exemplary Compounds above are as follows.
Ph: a phenyl group

Specific examples of the electron transport material include compounds represented by structural formulae (ET-A) to (ET-E) below besides the electron transport materials represented by general formula (2).

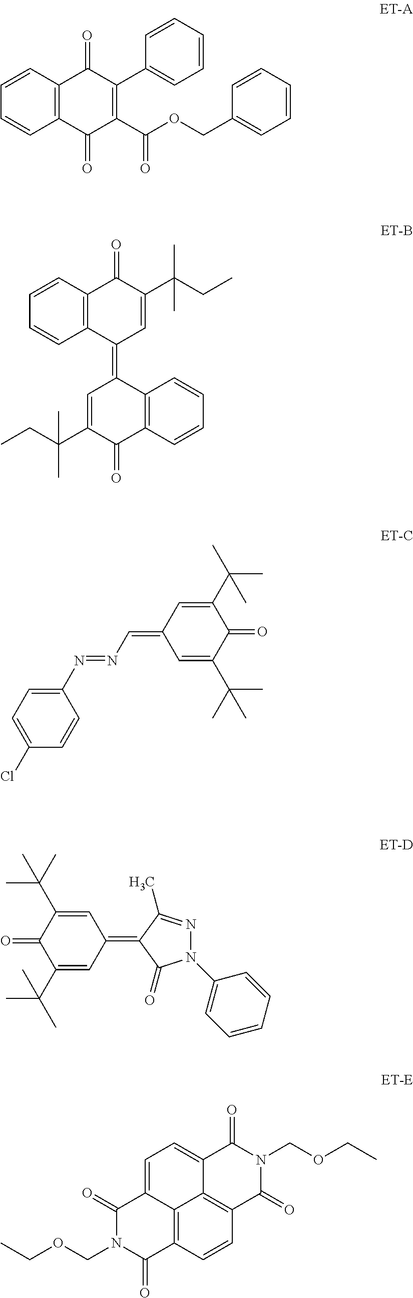

The electron transport materials represented by general formula (2) may be used alone or in combination of two or more thereof. When an electron transport material represented by general formula (2) is used, the electron transport material represented by general formula (2) and an electron transport material (for example, an electron transport material formed of a compound represented by any of structural formulae (ET-A) to (ET-E)) other than the electron transport material represented by general formula (2) may be used in combination.

When an electron transport material other than the electron transport material represented by general formula (2) is incorporated, the content thereof is preferably in a range of 10% by weight or less relative to the total of the electron transport material.

The content of the total electron transport material relative to the total solid content of the photosensitive layer is from 4% to 30% by weight, and preferably from 6% to 20% by weight.

### Weight Ratio of Hole Transport Material and Electron Transport Material

A ratio of the hole transport material to the electron transport material is preferably 50/50 or more and 90/10 or less, and more preferably 60/40 or more and 80/20 or less in terms of weight ratio (hole transport material/electron transport material).

### Other Additives

The single-layer photosensitive layer may contain known additives such as an antioxidant, a light stabilizer, a heat stabilizer, fluororesin particles, and silicone oil.

From the viewpoint of suppressing formation of color spots, the single-layer photosensitive layer of the photosensitive member according to the exemplary embodiment preferably contains at least one charge generation material selected from the hydroxygallium phthalocyanine pigment and the chlorogallium phthalocyanine pigment, a hole transport agent, and the electron transport material represented by general formula (2). From the same viewpoint, the single-layer photosensitive layer preferably contains the hole transport material represented by general formula (1) in addition to the charge generation material and the electron transport material.

### Formation of Single-Layer Photosensitive Layer

The single-layer photosensitive layer is formed by using a coating liquid for forming a photosensitive layer, the coating liquid being prepared by adding the above-described components to a solvent.

Examples of the solvent include typical organic solvents such as aromatic hydrocarbons, e.g., benzene, toluene, xylene, and chlorobenzene; ketones, e.g., acetone and 2-butanone; halogenated aliphatic hydrocarbons, e.g., methylene chloride, chloroform, and ethylene chloride; and cyclic or linear ethers, e.g., tetrahydrofuran and ethyl ether. These solvents may be used alone or as a mixture of two or more thereof.

In the method for dispersing particles (for example, the charge generation material) in the coating liquid for forming a photosensitive layer, a media dispersing device such as a ball mill, a vibration ball mill, an attritor, a sand mill, or a horizontal sand mill or a media-less dispersing device such as a stirrer, an ultrasonic dispersing device, a roll mill, or a high-pressure homogenizer is used. Examples of the high-pressure homogenizer include a collision-type homogenizer in which a dispersion is dispersed through liquid-liquid collision or liquid-wall collision under a high pressure, and a penetration-type homogenizer in which a dispersion is dispersed by causing the dispersion to penetrate through a narrow flow path under a high pressure.

Examples of the method for applying the coating liquid for forming a photosensitive layer include a dip coating method, a lift coating method, a wire bar coating method, a spray coating method, a blade coating method, a knife coating method, and a curtain coating method.

The thickness of the single-layer photosensitive layer is determined in the range of preferably from 5 to 60 μm, more preferably from 5 to 50 μm, and still more preferably from 10 to 40 μm.

### Image-Forming Apparatus (and Process Cartridge)

An image-forming apparatus according to the exemplary embodiment includes an electrophotographic photosensitive member, a charging unit that charges a surface of the electrophotographic photosensitive member, an electrostatic latent-image forming unit that forms an electrostatic latent image on the charged surface of the electrophotographic photosensitive member, a developing unit that develops the electrostatic latent image formed on the surface of the electrophotographic photosensitive member with a developer containing a toner to form a toner image, and a transfer unit that transfers the toner image onto a surface of a recording medium. The electrophotographic photosensitive member according to the exemplary embodiment is used as the electrophotographic photosensitive member.

The image-forming apparatus of the exemplary embodiment is applicable to commonly used image-forming apparatuses such as an apparatus including a fixing unit that fixes a toner image transferred to a surface of a recording medium; a direct-transfer-type apparatus that directly transfers a toner image formed on a surface of an electrophotographic photosensitive member directly onto a recording medium; an intermediate-transfer-type apparatus that transfers a toner image formed on the surface of the electrophotographic photosensitive member onto a surface of an intermediate transfer body (first transfer) and subsequently transfers the toner image on the surface of the intermediate transfer body onto a surface of the recording medium (second transfer); an apparatus including a cleaning unit that cleans a surface of an electrophotographic photosensitive member after transfer of a toner image and before charging; an apparatus including a charge-erasing device that erases charges by irradiating a surface of an image-carrying member with charge-erasing light after transfer of a toner image and before charging; and an apparatus including a member that heats an electrophotographic photosensitive member in order to increase the temperature of the electrophotographic photosensitive member and decrease the relative temperature.

According to the intermediate-transfer-type apparatus, the transfer unit includes, for example, an intermediate transfer body having a surface onto which a toner image is transferred, a first transfer unit that transfers the toner image formed on a surface of an image-carrying member onto a surface of the intermediate transfer body (first transfer), and a second transfer unit that subsequently transfers the toner image transferred on the surface of the intermediate transfer body onto a surface of a recording medium (second transfer).

The image-forming apparatus according to the exemplary embodiment may be a dry-development-type image-forming apparatus or a wet-development-type image-forming apparatus (development performed by using a liquid developer).

In the image-forming apparatus according to the exemplary embodiment, a unit including an electrophotographic photosensitive member may have a cartridge structure (process cartridge) that is detachably attachable to the image-forming apparatus. For example, a process cartridge including the electrophotographic photosensitive member according to the exemplary embodiment is suitably used as the process cartridge. The process cartridge may include, in addition to the electrophotographic photosensitive member, for example, at least one selected from a charging unit, an electrostatic latent-image forming unit, a developing unit, and a transfer unit.

An example of an image-forming apparatus according to the exemplary embodiment will now be described but is not limited thereto. The components illustrated in the drawings are described, and the description of other components is omitted.

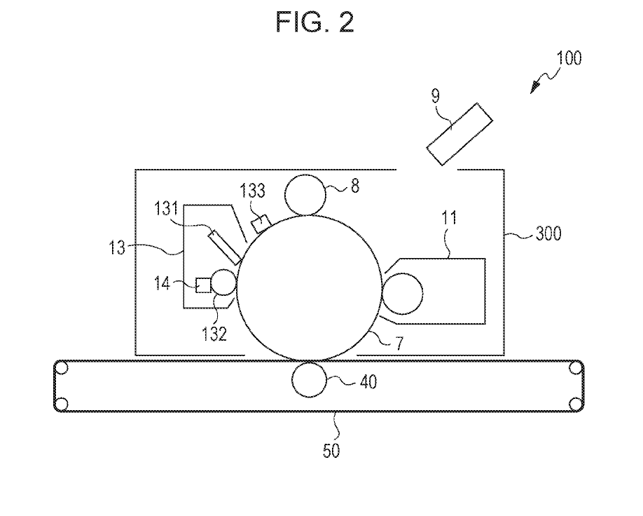

FIG. 2 is a schematic structural view illustrating an example of an image-forming apparatus according to the exemplary embodiment.

As illustrated in FIG. 2, an image-forming apparatus 100 according to the exemplary embodiment includes a process cartridge 300 including an electrophotographic photosensitive member 7, an exposure device 9 (an example of an electrostatic latent-image forming unit), a transfer device 40 (first transfer device), and an intermediate transfer body 50. In the image-forming apparatus 100, the exposure device 9 is arranged at a position so that the exposure device 9 applies light to the electrophotographic photosensitive member 7 through an opening in the process cartridge 300. The transfer device 40 is arranged at a position facing the electrophotographic photosensitive member 7 with the intermediate transfer body 50 therebetween. The intermediate transfer body 50 is arranged so that a part of the intermediate transfer body 50 is in contact with the electrophotographic photosensitive member 7. The image-forming apparatus 100 further includes a second transfer device (not shown) that transfers a toner image transferred to the intermediate transfer body 50 to a recording medium (for example, paper). The intermediate transfer body 50, the transfer device 40 (first transfer device), and the second transfer revice (not shown) correspond to examples of the transfer unit.

The process cartridge 300 in FIG. 2 integrally supports the electrophotographic photosensitive member 7, a charging device 8 (an example of a charging unit), a developing device 11 (an example of a developing unit), and a cleaning device 13 (an example of a cleaning unit) in the housing. The cleaning device 13 includes a cleaning blade 131 (an example of a cleaning member). The cleaning blade 131 is arranged to come in contact with a surface of the electrophotographic photosensitive member 7. The cleaning member is not limited to the cleaning blade 131. Alternatively, the cleaning member may be a conductive or insulating fibrous member. The conductive or insulating fibrous member may be used alone or in combination with the cleaning blade 131.

FIG. 2 illustrates an example of an image-forming apparatus including a fibrous member 132 (roll shape) that supplies a lubricant 14 onto the surface of the electrophotographic photosensitive member 7, and a fibrous member 133 (flat brush shape) that assists cleaning. These members are arranged as required.

Structures of the image-forming apparatus according to the exemplary embodiment will now be described.

### Charging Device

Examples of the charging device 8 include contact-type chargers that use, for example, conductive or semi-conductive charging rollers, charging brushes, charging films, charging rubber blades, or charging tubes, non-contact-type roller chargers, and known chargers such as scorotron chargers and corotron chargers that use corona discharge.

### Exposure Device

An example of the exposure device 9 is an optical device that illuminates the surface of the electrophotographic photosensitive member 7 with light from a semiconductor laser, an LED, a liquid crystal shutter, or the like so as to form a desired image on the surface. The wavelength of the light source is set to be within the range of the spectral sensitivity of the electrophotographic photosensitive member. Semiconductor lasers that are mainly used are near-infrared lasers having an oscillation wavelength about 780 nm. However, the wavelength is not limited to this, and a laser having an oscillation wavelength on the order to 600 nm or a blue laser having an oscillation wavelength of 400 nm or more and 450 nm or less may also be used. In order to form color images, a surface-emitting laser light source capable of outputting a multibeam is also effective.

### Developing Device

An example of the developing device 11 is a typical developing device that performs development by using a developer in a contact or non-contact manner. The developing device 11 is not limited as long as the device has the above function, and is selected in accordance with the purpose. An example thereof is a known developing device having a function of causing a one-component developer or a two-component developer to attach to the electrophotographic photosensitive member 7 with a brush, a roller, or the like. In particular, the developing device may use a developing roller that carries the developer on the surface thereof.

The developer used in the developing device 11 may be a one-component developer containing a toner alone or a two-component developer containing a toner and a carrier. The developer may be magnetic or nonmagnetic. Known developers are used as the developer.

### Cleaning Device

A cleaning blade-type device including the cleaning blade 131 is used as the cleaning device 13.

Besides the cleaning blade-type device, a fur brush cleaning-type device or a device that performs development and cleaning simultaneously may be employed.

### Transfer Device

Examples of the transfer device 40 include contact-type transfer charges that use, for example, belts, rollers, films, or rubber blades, and known transfer chargers such as scorotron transfer chargers and corotron transfer chargers that use corona discharge.

### Intermediate Transfer Body

The intermediate transfer body 50 may be a belt-shaped member (intermediate transfer belt) containing a polyimide, polyamide-imide, a polycarbonate, a polyarylate, a polyester, rubber, or the like that is provided with semiconductivity. The intermediate transfer body may have a drum shape instead of the belt shape.

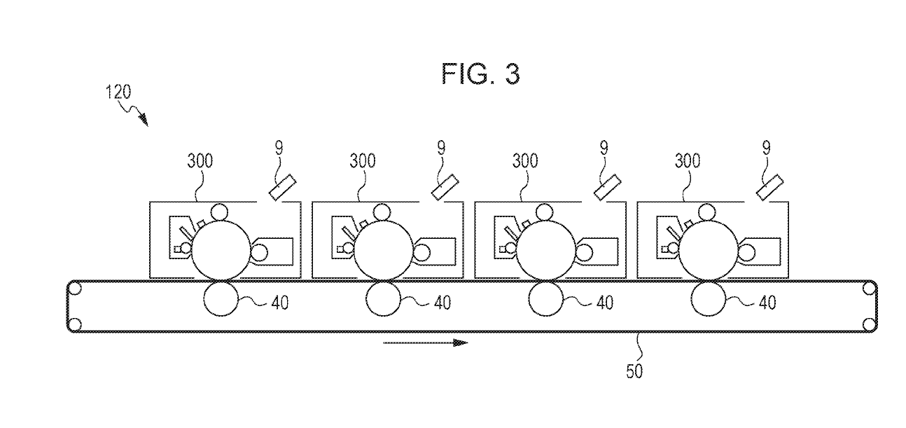

FIG. 3 is a schematic structural view illustrating another example of the image-forming apparatus according to the exemplary embodiment.

An image-forming apparatus 120 illustrated in FIG. 3 is a tandem-type multicolor image-forming apparatus including four process cartridges 300. In the image-forming apparatus 120, the four process cartridges 300 are arranged in parallel on an intermediate transfer body 50, and one electrophotographic photosensitive member is used for one color. The image-forming apparatus 120 has the same structure as the image-forming apparatus 100 except that the image-forming apparatus 120 is a tandem-type image-forming apparatus.

The structure of the image-forming apparatus 100 according to the exemplary embodiment is not limited to the structure described above. For example, a first charge-erasing device that makes the polarity of a residual toner uniform so that the toner is easily removed with a cleaning brush may be provided around the electrophotographic photosensitive member 7 on the downstream side of the transfer device 40 in a direction in which the electrophotographic photosensitive member 7 rotates and on the upstream side of the cleaning device 13 in the direction in which the electrophotographic photosensitive member rotates. Alternatively, a second charge-erasing device that erases charges from the surface of the electrophotographic photosensitive member 7 may be provided on the downstream side of the cleaning device 13 in the direction in which the electrophotographic photosensitive member rotates and on the upstream side of the charging device 8 in the direction in which the electrophotographic photosensitive member rotates.

The structure of the image-forming apparatus 100 according to the exemplary embodiment is not limited to the structure described above. The image-forming apparatus 100 may be, for example, a known direct-transfer-type image-forming apparatus that transfers a toner image formed on the electrophotographic photosensitive member 7 directly onto a recording medium.

### EXAMPLES

The present invention will now be described specifically by using Examples and Comparative Examples. However, the invention is not limited to the Examples described below.

In the description below, the term “part” refers to part by weight unless otherwise noted.

### Example 1

A total 1.5 parts by weight of a type V hydroxygallium phthalocyanine pigment (CG1) having diffraction peaks at Bragg angles (2θ±0.2°) of at least 7.3°, 16.0°, 24.9°, and 28.0° in an X-ray diffraction spectrum obtained using a CuKα X-ray and a chlorogallium phthalocyanine pigment (CG2) having diffraction peaks at Bragg angles (2θ±0.2°) of at least 7.4°, 16.6°, 25.5°, and 28.3° in an X-ray diffraction spectrum obtained using a CuKα X-ray (CG1:CG2 =3.5:6.5 (weight ratio)), the hydroxygallium phthalocyanine pigment (CG1) and the chlorogallium phthalocyanine pigment (CG2) serving as a charge generation material, 8 parts by weight of the electron transport material shown in Table 1, 36 parts by weight of the hole transport material shown in Table 1, 54.5 parts by weight of a bisphenol Z polycarbonate resin (viscosity-average molecular weight: 45,000) serving as a binder resin, and 250 parts by weight of tetrahydrofuran serving as a solvent are mixed. The resulting mixture is dispersed for four hours in a sand mill with glass beads having a diameter φ of 1 mm. Thus, a coating liquid for forming a photosensitive layer is obtained.

An aluminum base (with a cylindrical shape having a diameter of 30 mm, a length of 244.5 mm, and a wall thickness of 0.7 mm) is prepared. This aluminum base is immersed in a water tank containing water having a pH of 8.1 to wash the aluminum base. The aluminum base taken out from the water tank is dried. Subsequently, the coating liquid for forming a photosensitive layer is applied onto the aluminum base by a dip coating method. The applied coating liquid is dried at 125° C. for 24 minutes to form a single-layer photosensitive layer having a thickness of 22 μm. Thus, a photosensitive member is obtained.

The work function of the conductive base, ΔEa−Ip, and ΔIab are measured by the methods described above.

### Examples 2 to 8 and Comparative Examples 1 to 4

Photosensitive members are prepared as in Example 1 except that the washing conditions of the conductive base and the composition of the photosensitive layer are changed in accordance with Table 1.

### REFERENCE EXAMPLE

An aluminum base (with a cylindrical shape having a diameter of 30 mm, a length of 244.5 mm, and a wall thickness of 0.7 mm) is prepared. The aluminum base is polished with a centerless polishing device. Subsequently, a surface treatment with a 2% by weight sodium hydroxide solution, a neutralization treatment, and washing with pure water are performed in that order. Next, an anodic oxidation treatment (current density: 1.0 A/dm²) is performed on the surface of the cylinder with a 10% by weight sulfuric acid solution to form an anodic oxide coating. After washing with water, the aluminum base is immersed in a 1% by weight nickel acetate solution at 80° C. for 20 minutes to perform sealing. Washing with pure water and drying are further performed to obtain an aluminum base having an anodic oxide coating.

The coating liquid for forming a photosensitive layer, the coating liquid being prepared by the same procedure as that in Example 1, is applied onto the aluminum base having the anodic oxide coating by a dip coating method. The applied coating liquid is dried at 125° C. for 24 minutes to form a single-layer photosensitive layer having a thickness of 22 μm. Thus, a photosensitive member is obtained.

### Evaluations

The photosensitive members of Examples, Comparative Examples, and Reference Example are evaluated as described below. Table 1 shows the results.

### Evaluation of Sensitivity of Photosensitive Member

The sensitivity of the photosensitive member is evaluated as a half decay exposure after being charged to +800 V. Specifically, the photosensitive member is charged to +800 V in an environment at 20° C. and 40% RH by using an electrostatic paper analyzer (electrostatic analyzer EPA-8100, manufactured by Kawaguchi Electric Works Co., Ltd.). Subsequently, monochromatic light of 800 nm obtained from a tungsten lamp through a monochromator is applied onto the photosensitive member so that the amount of light becomes 1 μW/cm² on the surface of the photosensitive member.

A surface potential V₀ (V) of the surface of the photosensitive member immediately after charging and a half decay exposure E_{1/2} (μJ/cm²) at which the surface potential becomes 1/2×V₀ (V) as a result of the light irradiation on the surface of the photosensitive member are measured.

Regarding the evaluation standards of the sensitivity of the photosensitive member, when the half decay exposure is 0.2 μJ/cm² or less, it is determined that a high sensitivity is realized. Table 2 shows the results.

A (Good): 0.2 μJ/cm² or less

B (Not good): more than 0.2 μJ/cm²

### Image Quality (Color Spot) Evaluation

In the image quality evaluation, a white solid image is formed on 50 sheets by using an HL5340D printer manufactured by Brother Industries, Ltd., and a drum for measurement is then charged to +1300 V in an environment at 33° C. and 80% RH by using an electrostatic paper analyzer (electrostatic analyzer EPA-8100, manufactured by Kawaguchi Electric Works Co., Ltd.). Subsequently, a white solid image is again formed on 10 sheets by using the HL5340D printer manufactured by Brother Industries, Ltd. For the white solid image formed on the third sheet, the image quality is evaluated on the basis of the number of color spots corresponding to the positions at which leakage occurs on the drum.

It is determined that the evaluation results of G3 and G4 may cause problems in practical use.

### Evaluation Standards

G0: The number of color spots is 0. (No leakage defect)
G1: The number of color spots is 3 or less. (The number of leakage defects is 3 or less.)
G2: The number of color spots is 4 or more and 7 or less.
G3: The number of color spots is 8 or more and 10 or less.
G4: The number of color spots is 11 or more.

TABLE 1

| | Photosensitive layer | | | | | | | | | Conductive base | |
|---|---|---|---|---|---|---|---|---|---|---|---|
| | | | | | | Electron | | | | | Work |
| | Charge generation material | | | | | transport | | Hole transport | | | function |
| | | | | | Ea | material | | material | | | Ip |
| | Type | | Parts | Ratio | (eV) | Type | Parts | Type | Parts | Washing condition | (eV) |
| Example 1 | CG-1 | CG-2 | 1.5 | 3.5:6.5 | 3.91 | ET-1 | 8 | HT-1 | 36 | Water with pH 8.1 | 3.89 |
| Example 2 | CG-1 | CG-2 | 1.5 | 3.5:6.5 | 3.91 | ET-1 | 8 | HT-1 | 36 | Water with pH 9.2 | 3.98 |
| Example 3 | CG-1 | CG-2 | 1.5 | 3.5:6.5 | 3.91 | ET-1 | 8 | HT-1 | 36 | Water with pH 7.2 | 3.81 |
| Example 4 | CG-1 | CG-2 | 1.5 | 3.5:6.5 | 3.91 | ET-1 | 8 | HT-1 | 36 | Water with pH 9.4 | 4.01 |
| Example 5 | CG-1 | — | 1.5 | — | 4.01 | ET-1 | 8 | HT-1 | 36 | Water with pH 8.3 | 3.92 |
| Example 6 | — | CG-2 | 1.5 | — | 3.91 | ET-1 | 8 | HT-1 | 36 | Water with pH 7.2 | 3.81 |
| Example 7 | CG-1 | CG-2 | 1.5 | 3.5:6.5 | 3.91 | ET-1 | 8 | HT-1:HT-2 | 14:22 | Water with pH 7.2 | 3.81 |
| Example 8 | CG-1 | CG-2 | 1.5 | 7:3 | 4.01 | ET-1 | 8 | HT-1 | 36 | Water with pH 9.4 | 4.01 |
| Comparative | CG-1 | CG-2 | 1.5 | 3.5:6.5 | 3.91 | ET-2 | 8 | HT-1 | 36 | Water with pH 8.1 | 3.89 |
| Example 1 | | | | | | | | | | | |
| Comparative | CG-3 | — | 1.5 | — | 3.76 | ET-1 | 8 | HT-1 | 36 | Water with pH 8.1 | 3.89 |
| Example 2 | | | | | | | | | | | |
| Comparative | CG-1 | CG-2 | 1.5 | 3.5:6.5 | 3.91 | ET-1 | 8 | HT-1 | 36 | Water with pH 9.7 | 4.03 |
| Example 3 | | | | | | | | | | | |
| Comparative | CG-1 | CG-2 | 1.5 | 3.5:6.5 | 3.91 | ET-1 | 8 | HT-1 | 36 | Water with pH 6.7 | 3.78 |
| Example 4 | | | | | | | | | | | |
| Reference | CG-1 | CG-2 | 1.5 | 3.5:6.5 | 3.91 | ET-1 | 8 | HT-1 | 36 | Anodic oxidation | 2.00 |
| Example | | | | | | | | | | | |

TABLE 2

| | | | Sensitivity | | Image quality |
|---|---|---|---|---|---|
| | | Δlab | E_{1/2} | | (Color spots) |
| | ΔEa − Ip | [A/cm²] | [μJ/cm²] | Evaluation | Evaluation |
| Example 1 | 0.02 | 6.54 × 10⁻⁸ | 0.18 | A (Good) | G1 |
| Example 2 | −0.07 | 8.71 × 10⁻⁸ | 0.18 | A (Good) | G2 |
| Example 3 | 0.10 | 5.67 × 10⁻⁸ | 0.18 | A (Good) | G0 |
| Example 4 | −0.10 | 9.06 × 10⁻⁸ | 0.18 | A (Good) | G2 |
| Example 5 | 0.09 | 6.01 × 10⁻⁸ | 0.18 | A (Good) | G0 |
| Example 6 | 0.10 | 7.53 × 10⁻⁸ | 0.20 | A (Good) | G0 |
| Example 7 | 0.10 | 9.20 × 10⁻⁸ | 0.19 | A (Good) | G2 |
| Example 8 | 0.00 | 5.53 × 10⁻⁸ | 0.18 | A (Good) | G0 |
| Comparative | 0.02 | 1.48 × 10⁻⁷ | 0.22 | B (Not good) | G4 |
| Example 1 | | | | | |
| Comparative | −0.13 | 9.76 × 10⁻⁸ | 0.21 | B (Not good) | G3 |
| Example 2 | | | | | |
| Comparative | −0.12 | 1.34 × 10⁻⁷ | 0.18 | A (Good) | G4 |
| Example 3 | | | | | |
| Comparative | 0.13 | 4.67 × 10⁻⁸ | 0.18 | A (Good) | G3 |
| Example 4 | | | | | |

Details of abbreviations etc. in Table 1 are as follows.

Charge generation material
CG1: Type V hydroxygallium phthalocyanine pigment: The hydroxygallium phthalocyanine pigment has diffraction peaks at Bragg angles (2θ±0.2°) of at least 7.3°, 16.0°, 24.9°, and 28.0° in an X-ray diffraction spectrum obtained using a CuKα X-ray. (maximum peak wavelength in a spectral absorption spectrum in a wavelength range of from 600 to 900 nm: 820 nm, average particle size: 0.12 μm, maximum particle size: 0.2 μm, BET specific surface area: 60 m²/g.)
CG2: Chlorogallium phthalocyanine pigment: The chlorogallium phthalocyanine pigment has diffraction peaks at Bragg angles (2θ±0.2°) of at least 7.4°, 16.6°, 25.5°, and 28.3° in an X-ray diffraction spectrum obtained using a CuKα X-ray. (maximum peak wavelength in a spectral absorption spectrum in a wavelength range of from 600 to 900 nm: 780 nm, average particle size: 0.15 μm, maximum particle size: 0.2 μm, BET specific surface area: 56 m²/g)
CG3: Type Y titanyl phthalocyanine pigment: The titanyl phthalocyanine pigment has diffraction peaks at Bragg angles (2θ±0.2°) of at least 9.6° and 27.3° in an X-ray diffraction spectrum obtained using a CuKα X-ray.

### Electron Transport Material

ET-1: Exemplary Compound (2-2) of electron transport material represented by general formula (2)
ET-2: Electron transport material represented by structural formula (ET-C)

### Hole Transport Material

HT-1: Hole transport material represented by structural formula (HT-D)
HT-2: Exemplary Compound (1-1) of hole transport material represented by general formula (1)

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photosensitive member comprising:
a conductive base; and
a single-layer photosensitive layer disposed directly on the conductive base and containing a binder resin, a charge generation material, a hole transport material, and an electron transport material,
wherein a difference ΔEa−Ip between a work function Ip of the conductive base and an electron affinity Ea of the charge generation material is in a range of from about −0.1 to about +0.1 eV, and
a difference ΔIab between a current Ia [A/cm²] and a current Ib [A/cm²] is in a range of from about 5.5×10⁻⁸ to about 9.2×10⁻⁸ [A/cm²] when a gold electrode is provided on the photosensitive layer so as to have a film thickness of 2 nm and an electrode area of 9.3×10⁻¹ cm^{2,} where the current Ia is a current that flows per unit area when an electric field of 27 V/μm is applied between the photosensitive layer and the conductive base in an environment at a temperature of 33° C. and a humidity of 80% by applying a voltage so that the gold electrode becomes positive, and the current Ib is a current that flows per unit area when an electric field of 27 V/μm is applied between the photosensitive layer and the conductive base in the environment by applying a voltage so that the conductive base becomes positive.

2. The electrophotographic photosensitive member according to claim 1, wherein the difference ΔIab is in a range of from about 5.5×10⁻⁸ to about 8.0×10⁻⁸ [A/cm²].

3. The electrophotographic photosensitive member according to claim 1, wherein the photosensitive layer contains at least one charge generation material selected from a hydroxygallium phthalocyanine pigment and a chlorogallium phthalocyanine pigment as the charge generation material, a hole transport material represented by general formula (1) as the hole transport material, and an electron transport material represented by general formula (2) as the electron transport material: 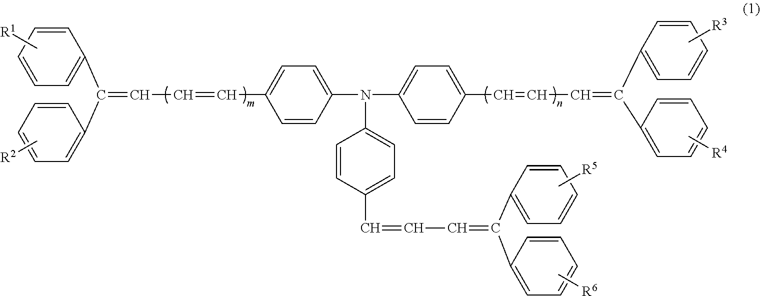
where R¹, R², R³, R⁴, R⁵, and R⁶ each independently represent a hydrogen atom, an alkyl group, an alkoxy group, a phenoxy group, a halogen atom, or a phenyl group optionally substituted with an alkyl group, an alkoxy group, or a halogen atom; and m and n each independently represent 0 or 1, 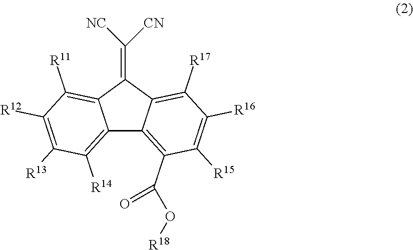
where R¹¹, R¹², R¹³, R¹⁴, R¹⁵, R¹⁶, and R¹⁷ each independently represent a hydrogen atom, a halogen atom, an alkyl group, an alkoxy group, an aryl group, or an aralkyl group; and R¹⁸ represents an alkyl group, -L¹⁹-O—R²⁰, an aryl group, or an aralkyl group where L¹⁹ represents an alkylene group and R²⁰ represents an alkyl group.

4. The electrophotographic photosensitive member according to claim 3, wherein the charge generation material contains a hydroxygallium phthalocyanine pigment.

5. The electrophotographic photosensitive member according to claim 3, wherein the charge generation material contains a hydroxygallium phthalocyanine pigment and a chlorogallium phthalocyanine pigment.

6. The electrophotographic photosensitive member according to claim 5,
wherein the charge generation material contains a hydroxygallium phthalocyanine pigment and a chlorogallium phthalocyanine pigment, and
a weight ratio of the hydroxygallium phthalocyanine pigment to the chlorogallium phthalocyanine pigment is from about 3:7 to about 7:3.

7. The electrophotographic photosensitive member according to claim 3, wherein R¹⁸ in the electron transport material represented by general formula (2) is an alkyl group.

8. The electrophotographic photosensitive member according to claim 7, wherein R¹⁸ in the electron transport material represented by general formula (2) is an alkyl group having from 1 to 12 carbon atoms.

9. A process cartridge detachably attachable to an image-forming apparatus, the process cartridge comprising:
the electrophotographic photosensitive member according to claim 1.

10. An image-forming apparatus comprising:
the electrophotographic photosensitive member according to claim 1;
a charging unit that charges a surface of the electrophotographic photosensitive member;
an electrostatic latent-image forming unit that forms an electrostatic latent image on the charged surface of the electrophotographic photosensitive member;
a developing unit that develops the electrostatic latent image formed on the surface of the electrophotographic photosensitive member with a developer containing a toner to form a toner image; and
a transfer unit that transfers the toner image onto a surface of a recording medium.
